(19) United States
(12) Patent Application Publication
(10) Pub. No.: US 2012/0039150 A1
(43) Pub. Date: Feb. 16, 2012

(54) UNIQUE SEISMIC SOURCE ENCODING

(75) Inventors: Peter M. Eick, Houston, TX (US); Joel D. Brewer, Houston, TX (US)

(73) Assignee: ConocoPhillips Company, Houston, TX (US)

(21) Appl. No.: 13/192,222

(22) Filed: Jul. 27, 2011

Related U.S. Application Data
(60) Provisional application No. 61/372,759, filed on Aug. 11, 2010.

(51) Int. Cl. G01V 1/36

(52) U.S. Cl. 367/41

(57) ABSTRACT

The invention relates to the acquisition of seismic data using many seismic sources simultaneously or where the sources are emitting in an overlapping time frame but where it is desired to separate the data traces into source separated data traces. The key is having each seismic source emit a distinctive pattern of seismic energy that may all be discerned in the shot records of all of the seismic receivers. Distinctive patterns are preferably based on time/frequency pattern that is distinctive like an easily recognized song, but may include other subtle, but recognizable features such a phase differences, ancillary noise emissions, and physical properties of the vibes such a the weight and shape of the pad and the reaction mass and the performance of the hydraulic system and prime energy source.

### CROSS-REFERENCE TO RELATED APPLICATIONS

This application is a non-provisional application which claims benefit under 35 USC §119(e) to U.S. Provisional Application Ser. No. 61/372,759 filed Aug. 11, 2010, “Unique Seismic Source Encoding,” which is incorporated herein in its entirety.

### STATEMENT REGARDING FEDERALLY SPONSORED RESEARCH OR DEVELOPMENT

None.

### FIELD OF THE INVENTION

This invention relates to the acquisition of seismic data by sending seismic energy into the earth and recording the wave field returning from the subsurface and more particularly related to sources for emitting seismic energy into the earth.

### BACKGROUND OF THE INVENTION

The process of acquiring seismic energy is very expensive when considering the number of people and the cost and amount of equipment that must be mobilized to the field and considering the time spent in the field, even for a small survey. Any manner to reduce costs or days in the field can add up to significant money. One effort to reduce costs is to increase the volume of data that is concurrently recorded by operating several seismic sources at the same time. Various techniques have been developed for concurrently operated seismic sweep sources including phase separation and slip sweep or distance separated techniques. With these techniques, the traces recorded by the seismic receivers may be source separated. However, phase separation and slip sweep technology will only permit the distinction of a limited number of seismic sources that may be source separated within the trace recordings.

In operating seismic sources in phase separation, all of the sources in a group must begin to emit at the nearly the same time so as to coordinate the delivery of seismic energy and orient the delivery so the each source is in a different phase. This generally requires some waiting, especially if groups of four or more vibes are expected to work in the group as there is always a last vibe that takes longer to get to its shot point. If there are four vibes, each sweep will be run at least four times with each vibe taking a different phase separation with respect to the others so that in subsequent processing that the various sources will be more clearly separated. While several fleets of vibes may be operating concurrently, the fleets must each start at separate times to provide adequate separation for phase separation.

### BRIEF SUMMARY OF THE DISCLOSURE

The invention more particularly relates to a process for acquiring seismic data from subsurface geological structures where seismic receivers are deployed for receiving seismic energy reflected from the subsurface geological structures and a plurality of seismic sources move from location to location to emit seismic energy into the ground to be reflected by the subsurface geological structures. The plurality of seismic sources are provided with distinctive patterns for emitting seismic energy such that each seismic source may move to a desired location for emitting seismic energy and emit its distinctive pattern of seismic energy without regard to whether any other seismic source is emitting or ready to emit.

### BRIEF DESCRIPTION OF THE DRAWINGS

A more complete understanding of the present invention and benefits thereof may be acquired by referring to the follow description taken in conjunction with the accompanying drawings in which:

FIG. 1 is a chart showing a conventional upsweep of seismic energy delivered by a sweep-style seismic source;

FIG. 2 is a chart showing a distinctively different sweep of seismic energy delivered by a sweep-style seismic source;

FIG. 3 is a chart showing a more distinctively different sweep of seismic energy delivered by a sweep-style seismic source;

FIG. 4 is a chart showing a third, more distinctively different sweep of seismic energy delivered by a sweep-style seismic source;

FIG. 5 is a chart showing a fourth and even more distinctively different sweep of seismic energy delivered by a sweep-style seismic source;

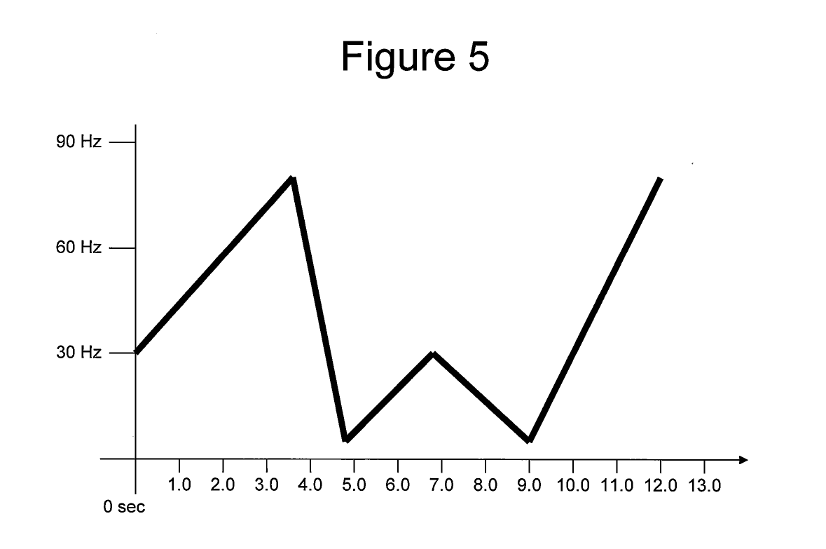

FIG. 6 is a chart showing a fifth and further distinctive simplistic sweep of seismic energy delivered by a sweep-style seismic source

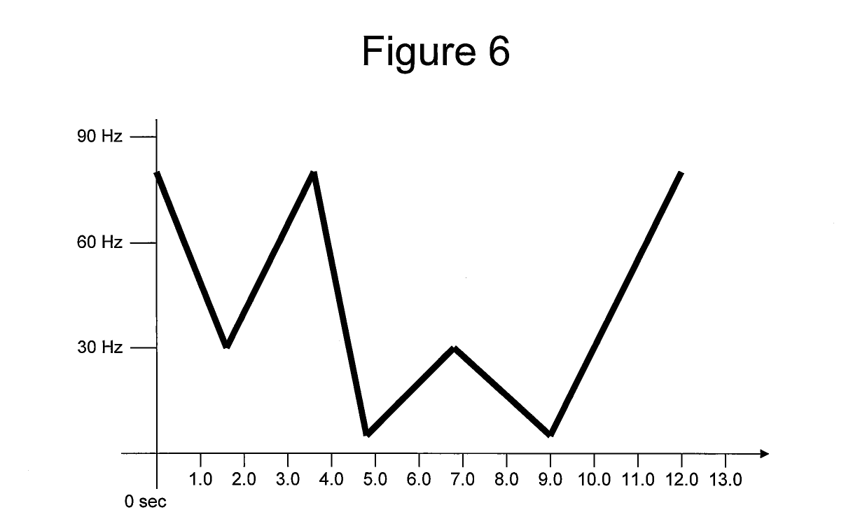

FIG. 7 is a graphical representation of sweep based on music from Bach;

FIG. 8 is a graphical representation of sweep based on broadband rock and roll music;

FIG. 9 is a graphical representation of sweep based on classic rock and roll music; and

FIG. 10 is a graphical representation of sweep based on classical music.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

Current technology for designing and constructing seismic sources, like all commercial efforts for manufacturing any mechanical device, has been focused on producing products that are all the same. Productivity and reliability are enhanced by uniformity. However, it is an observation of the present inventors that uniformity may actually be a negative quality for seismic source equipment. Uniformity is a problem for source separation. Distinguishing each source from other sources while a number of sources are emitting seismic energy is easiest and most certain when each source is distinctive and different from the others. For example, if two people are speaking in a room whether talking back and forth or talking over one another, it is very easy to distinguish one from another from outside the room if one is a man and the other is a woman. If one has a very different accent or other distinctive speaking quality, the two voices are easier to separate. But listening to two people that sound very similar speaking back and forth and sometime over top of one another becomes a real test for discernment.

Similarly, if a geoscientist is attempting to separate, with the help of computers, the source of seismic data blended together in one recorded trace, it would be easier and better if the sources were more different and distinct from one another. It has been found that older, more worn vibratory seismic sources will undertake considerably different source signatures when run at or near full energy output. In particular, in two successive surveys using the same equipment, the sources were run at nearly full power output. In the second survey, the same sources were run at more conventional power outputs of around 80% of full power. In the post acquisition processing of these two surveys, source separation was much more ambiguous in the second survey as compared to the first due to the harmonic distortion caused by the different wear patterns of the vibes operating at full power. This was easily seen in the source generated data contamination in the shot records post inversion. The surveys where the vibes were run at full power have less source generated data contamination than the more conventional 80% drive level. With this observation, it is believed that the sources running at full power were not able to emit a true or pure frequency pattern but rather imparted the true frequency with additional harmonics or other frequency components that yielded a more unique or distinctive quality which is easier to identify and separate. This process is easily heard in any college dormitory when a stereo war starts. As the individual participants keep cranking their stereos up, the sound gets more and more distorted and the unique aspects of each stereo become obvious. When the sources were not stressed, they essentially sounded more alike and less distinguishable. Perhaps this occurs because of mainly different wear patterns or simply because of slight manufacturing differences between source units. However, driving the sources at a high energy output make the sources sound different in a way that can be more clearly recognized by computer source separation using the derived ground force estimate from the vibe controller.

However, rather than rely on these slight differences that are exaggerated under unusually loading, the sources can be manufactured or operated to “sound” different. Alternatively, the sources can simply be operated with different input sounds or sweeps. Currently, vibes are programmed to provide a continuous energy input to the earth from a low frequency to a high frequency. This is often called a “sweep” or an “upsweep”. Sweeps may also start at a high frequency and end at a low frequency which is called a “downsweep”. A sweep has little distinctness. Perhaps one could start at a lower or higher frequency and end at a lower or higher frequency, but the effective frequency range is pretty settled. One might alter the rate at which the sweep progresses such as a four second sweep from 4 Hz to 80 Hz versus a sixteen second sweep. According to the present invention, operating the vibe so that a sweep is comprised of high, mid and low frequency in a distinctive pattern would be distinctive from a simple upsweep.

Essentially, the vibe could play a song into the ground that comprises sufficient energy across the frequency range with sufficient dwell time at respective portions of the range to create a wave field response from the subsurface that is recordable and processible for seismic interpretation. This is the basic application of the present invention in that the source simply provides energy with sufficient time in each frequency band and make the energy pattern unique enough to separate out. Fancy and highly distinctive patterns may permit a greater number of sources to be emitting at one time, but the patterns only need to be “sufficiently” distinctive to do source separation.

Considering the distinctiveness that can be created by the variety of frequencies patterns once freed of the monotonous sweeps, the number of actual vibes that can be emitting seismic energy at one time that can also be source separated from the dataset can be considerable. If eight vibes seem like a large and intensive survey, eighty vibes might be a conventional survey in the future. With each vibe having its own distinctive “song”, the vibes do not have to wait on other vibes. Once a vibe reaches its shot point, it can begin to emit until it has completed its “song”. However, there is nothing to stop a crew from using the “song” approach with a standard ZenSeis® or similar acquisition technique. This means that the source would output a song of a sweep rather than the conventional upsweep and repeat it multiple times so there would be an equal or greater number of sweeps as there are active sources in the setup. Once the desired energy is put into the ground, the source will simply move on to the next shot point.

When the weather is suitable for seismic surveying, massively large areas will be surveyed in a few days and at far less cost simply based on the marginal costs of the additional vibes in the field. The shot points will have necessarily been shaken just the same, but the recorders will have recorded much denser information and the base costs that accumulate at a day rate, such as for processing equipment an oversight will have been reduced.

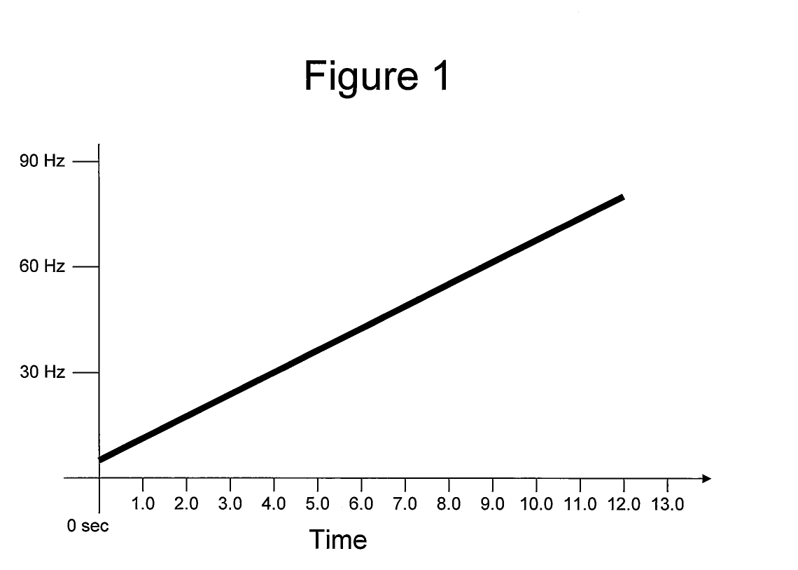

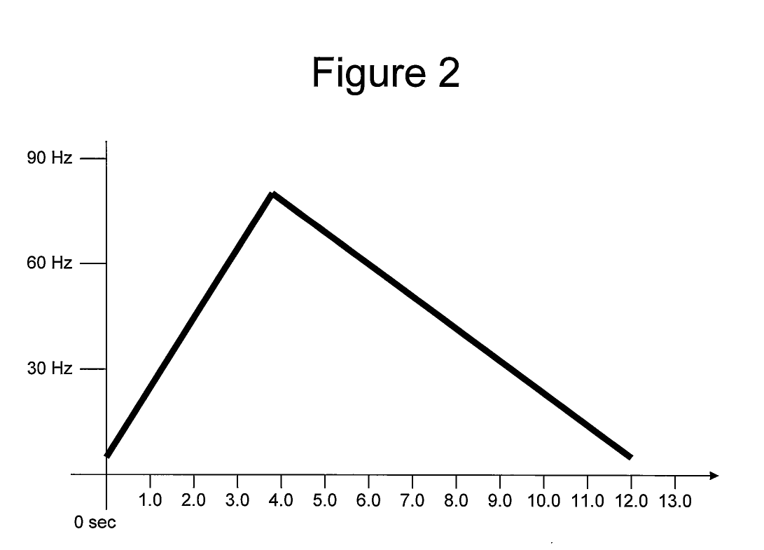

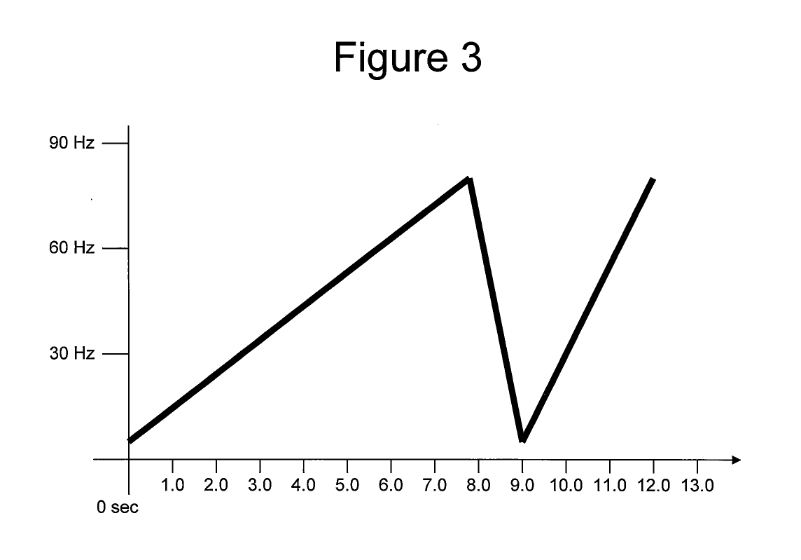

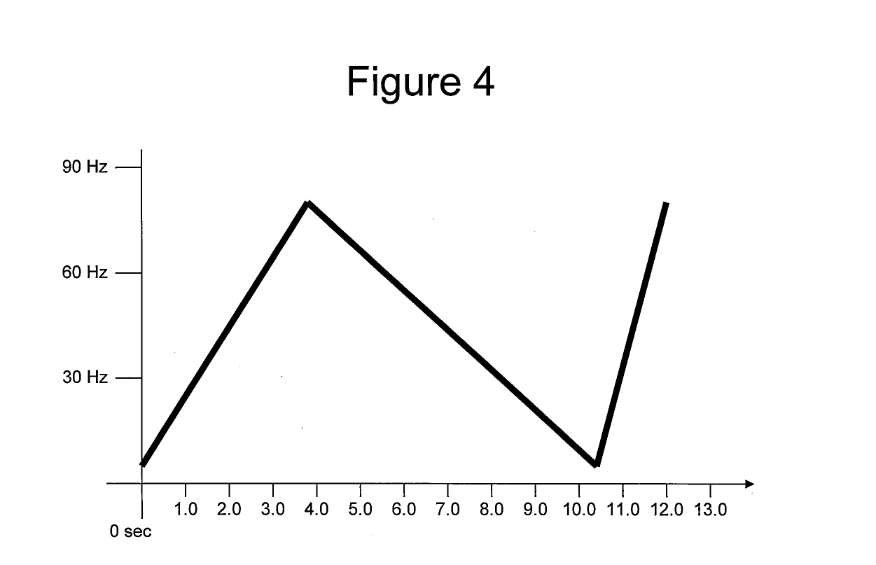

As shown in FIG. 1, an upsweep frequency pattern 10 is shown for a traditional upsweep. The frequency begins at 5 Hz and progresses to a high frequency of 80 Hz over 12 seconds. In FIG. 2, a first distinctive pattern 20 is shown that is distinctively different than the upsweep of FIG. 1. However, the pattern 20 extends from the same 5 Hz to 80 Hz and all of the frequencies between 5 and 80 Hz are covered for a period of time such that the frequency spectrum of the shot record would not have gaps. The distinctive sweep is also 12 seconds like upsweep pattern 10. In FIG. 3, a second distinctive pattern 30 is shown that is distinctively different than upsweep 10 and distinctive from first unique pattern 20. In FIG. 4, a third distinctive pattern 40 is shown that is distinctively different than upsweep 10, first distinctive pattern 20 and second distinctive pattern 30.

In FIGS. 2, 3, and 4, examples of some of the variations in the frequency pattern are shown. If these sweeps are combined with phase shifting techniques and each source in the fleet were to emit the different sweeps in order, then the sources could be separated with greater accuracy and ease because each sweep is unique.

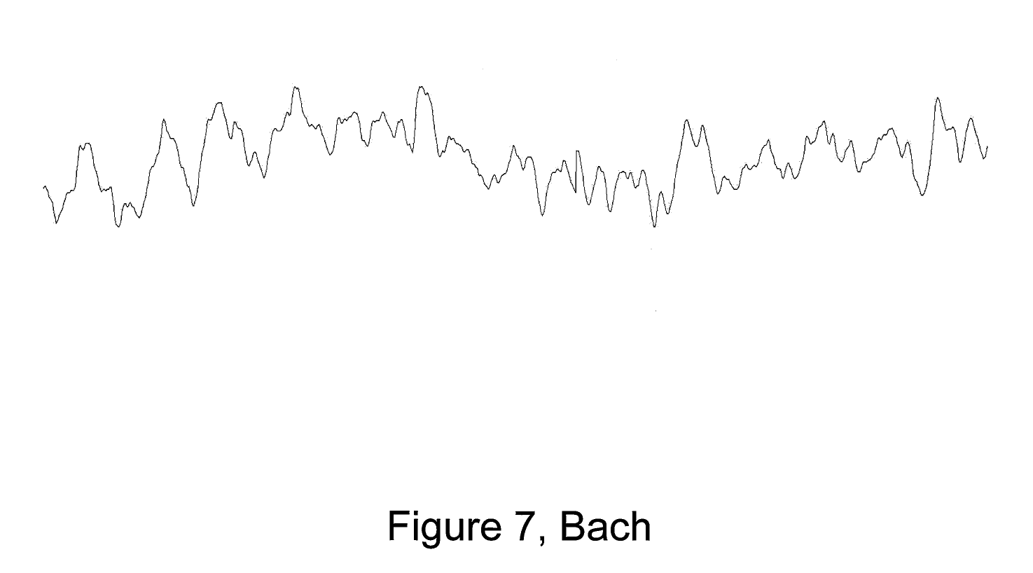

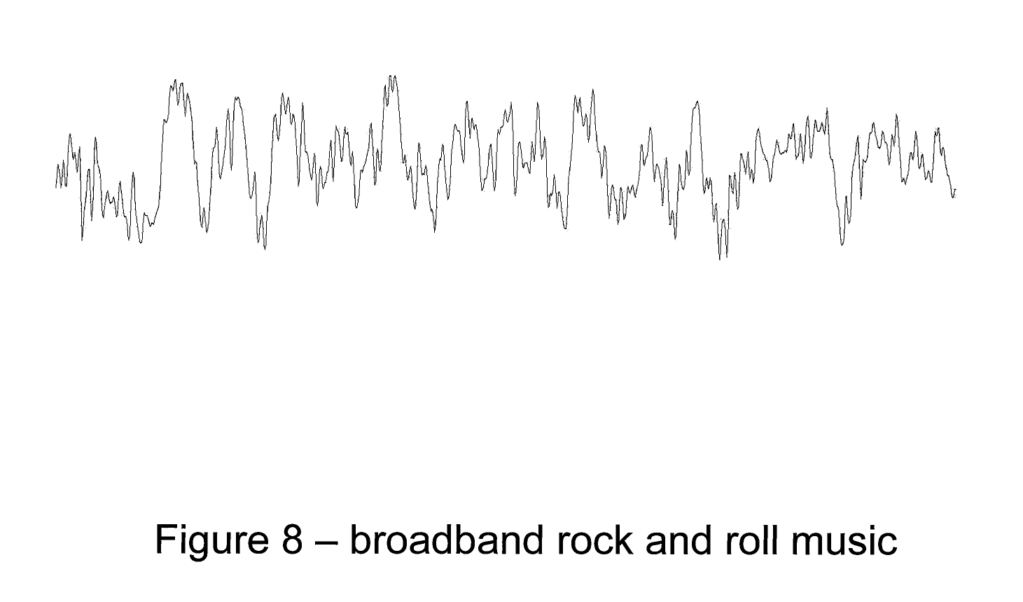

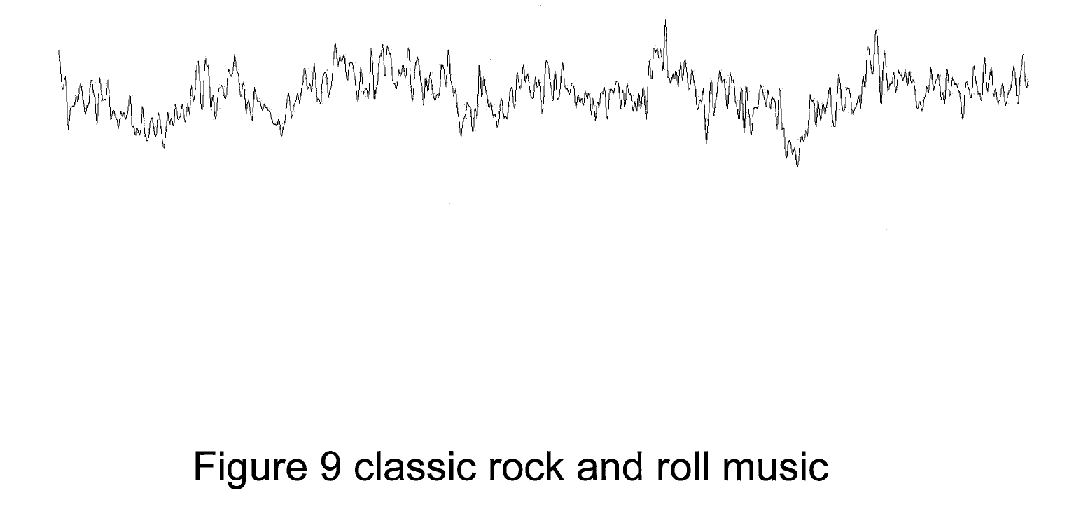

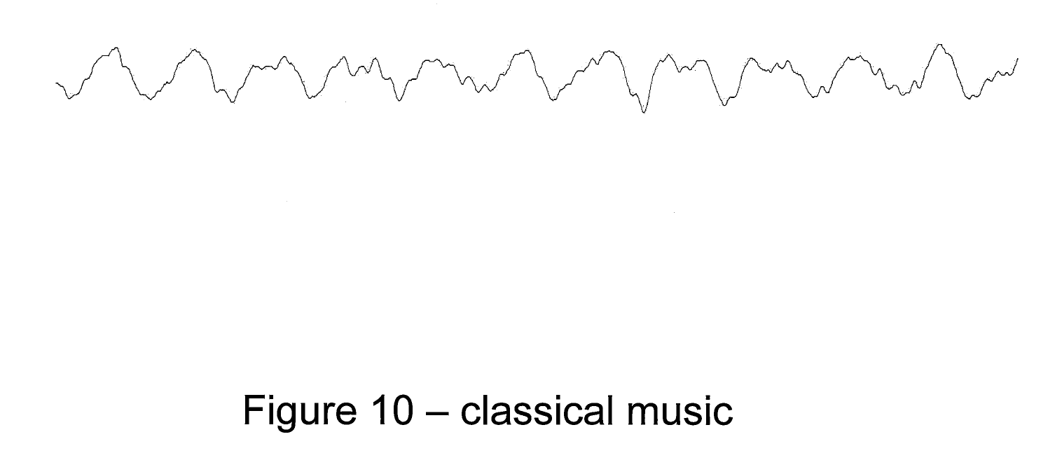

Finally, the sources may be source separable if each is provided with a slightly different construction to provide a distinction somewhat comparable to musical timbre distinctions. Musical timbre is how one distinguishes a clarinet from a piano, even if each is playing the exact same note at the same volume. They simply sound different. Even a clarinet sounds different than a saxophone. In the same way, sources may be constructed or modified to give each a slightly, or perhaps substantially, different ancillary frequency components. In the example above where each of the sources were run at full load created this type of distinctness, which may be simply termed “timbre distinctness”. Turning our attention now to real examples of sounds or songs that could be played by the source that would be distinctive we have several issues to overcome. First off, the music must be re-sampled so it is representative of what the vibe can play. Thus, the music is first filtered to the desired bandwidth of the final data set desired. Next, the music is re-sampled from a wave or mp3 file to a sweep file using readily available mathematical prototyping software like Matlab R2010a. Finally an appropriate amount of music is selected so that over the course of the song a uniform distribution of energy in all bands desired is input into the earth. FIG. 7 shows what would happen if in appropriate music is chosen. Note that the organ music is very spiky in the power amplitude spectrum. Thus, some frequencies would have significantly more energy input into the ground than other frequencies. This would lead to a very unbalanced power source amplitude spectrum and a poor source. FIGS. 8 and 9 show examples of rock and roll music that while it is a bit spiky in this instantaneous power spectrum, it is on average evenly balanced over the desired bandwidth. FIG. 10 shows some classical music that is a bit soft in the lows and highs and thus will need some minor equalization or maybe a different portion of the music can be chosen that results in a more uniform amplitude spectrum. These are just instantaneous examples of the types of music that could be chosen. The key is to sample the right type of music or sound pattern that is distinctive from all other sources and collect enough of it that the overall power spectrum is flat for the source. Intrinsically, we all can tell the difference with our ear between classical, modern and rock and roll, and there is no difference to the earth and computer either.

In one embodiment of the invention, a broad band signal pattern that covers the frequency band desired for the source signature to be imparted into the earth is utilized. The broad band signal pattern is decomposed into discrete sinusoidal frequency patterns that when summed create the broad band signal pattern. The decomposition is easily done by using industry standard fourier transform algorithms that transform a broad band data pattern, signal pattern in this case, into a frequency-domain representation. The frequency-domain representation can be perceived as three dimensional, one axis is frequency, one axis is amplitude and one axis is time. A random phase shift is applied to each discrete frequency axis to create a new representation. The resulting representation is then summed over all the frequency bands to create a variation on the original broad band signal pattern that is unique to the original signal pattern. This is repeated with the original broad band signal pattern making sure each time the phase shifts applied are unique relative to previous representations assuring each variation is unique. This is repeated as many times as needed to create as many unique variations as needed. The variations can be checked for uniqueness by cross-correlating pairs testing all combinations. The lower the cross-correlation coefficient the more unique the signal pattern variation.

In an alternate embodiment, sound patterns that already exist, such as music, are utilized as the signal pattern. The sound pattern is selected that has a suitable frequency spectrum so that when the spectrums are stretched to obtain frequencies desired for broad band seismic signals the frequency spectrum of the resulting signal pattern covers the desired spectrum uniformly. Several sound patterns are chosen and stretched to obtain seismic suitable signal patterns. The signal patterns are checked for uniqueness by cross-correlating pairs testing all combinations. The lower the cross-correlation coefficient the more unique the signal pattern variation.

Applicants sometimes use the term “unique” to mean distinctive from all other patterns for vibes in the area. As should be discerned from Figures, many, many distinctive patterns can be created and implemented to deploy many vibes into the field.

In closing, it should be noted that the discussion of any reference is not an admission that it is prior art to the present invention, especially any reference that may have a publication date after the priority date of this application. At the same time, each and every claim below is hereby incorporated into this detailed description or specification as additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A process for acquiring seismic data from subsurface geological structures where seismic receivers are deployed for receiving seismic energy reflected from the subsurface geological structures and a plurality of seismic sources move from location to location to emit seismic energy into the ground to be reflected by the subsurface geological structures wherein the plurality of seismic sources are provided with distinctive patterns for emitting seismic energy such that each seismic source may move to a desired location for emitting seismic energy and emit its distinctive pattern of seismic energy without regard to whether any other seismic source is emitting or ready to emit.

2. The process for acquiring seismic energy according to claim 1 wherein at least one distinctive pattern is distinctive from all others based on delivering energy across a frequency range in a pattern that is not a simple upsweep or a downsweep but includes all frequencies between an upper and lower frequency with at least one progression from a lower frequency to higher frequency and at least one progression and from a higher frequency to a lower frequency.

3. The process for acquiring seismic energy according to claim 2 wherein at least four different seismic sources are operated within a survey area and where all have patterns that are distinctive from all others and where no more than one is a simple upsweep or downsweep.

4. The process for acquiring seismic energy according to claim 3, wherein the source separation is additionally based on phase separation.

5. The process for acquiring seismic energy according to claim 2 wherein at least two different seismic sources are operated within a survey area and where all have patterns that are distinctive from all others and where no more than one is a simple upsweep or downsweep and the sources execute at least as many source sweeps as active source units.

6. The process for acquiring seismic energy according to claim 1, wherein the source separation is based on timbre distinctness.

7. The process for acquiring seismic energy according to claim 6, wherein the source separation is additionally based on phase separation.

8. The process for acquiring seismic energy according to claim 1, wherein the source separation is based on a pattern of frequency distinctness.

9. The process for acquiring seismic energy according to claim 8, wherein the source separation is additionally based on phase separation.

10. The process for acquiring seismic energy according to claim 1, wherein the source separation is based on a combination of timbre distinctness and patterns of frequency distinctness.

11. The process for acquiring seismic energy according to claim 10, wherein the source separation is additionally based on phase separation.
